(19) United States
(12) Patent Application Publication
(10) Pub. No.: US 2026/0036330 A1
(43) Pub. Date: Feb. 5, 2026

(54) DAMPER ASSEMBLY-CONTAINING CONNECTOR AND METHOD OF USE

(71) Applicant: Royal Metal Products, Temple, GA (US)

(72) Inventors: Jordan STRUNK, Portland, TN (US); Andrew MATTHEWS, Cookeville, TN (US); Kevin MCCABE, Ave Maria, FL (US)

(73) Assignee: Royal Metal Products, Temple, GA (US)

(21) Appl. No.: 19/283,660

(22) Filed: Jul. 29, 2025

Related U.S. Application Data
(60) Provisional application No. 63/676,967, filed on Jul. 30, 2024.

(51) Int. Cl. F24F 13/14; F24F 13/20

(52) U.S. Cl. CPC F24F 13/1426; F24F 13/20

(57) ABSTRACT

A damper assembly-containing connector includes a foam insulation layer that surrounds at least a portion of the connector. The foam insulation layer seals openings associated with a damper rod of the damper assembly to reduce leakage of air flowing through the connector. The foam insulation layer also includes a surface profile that is configured to position a control arm of the damper assembly in a first operating position on a portion of the surface of the foam insulation layer. The control arm can be moved from a recess of the surface profile to position the control arm in at least a second location and second operating position to adjust the position of the damper plate of the damper assembly for air flow control.

### FIELD OF THE INVENTION

A damper assembly-containing connector includes foam insulation surrounding a part thereof, the foam insulation including a specially configured section of the foam that functions to hold the damper lever or control arm in a desired location for damper placement and to minimize leakage of air from the connector.

### BACKGROUND OF THE INVENTION

An HVAC connector such as a take-off are well known in the HVAC industry. These take offs normally include a housing that has an outlet and inlet. A flange is arranged at the inlet for connection to a main duct line or branch line. The take-off acts as a connector between the main duct or trunk line and one end of a branch line, typically a flexible duct, wherein the flexible duct supplies conditioned or unconditioned air from the main duct or trunk line to another connector like a register box, the register box supplying the conditioned or unconditioned air to a space in a structure like a building.

Typically, the flange is shaped to engage with the main duct or trunk line; it could have a flat or planar face if the surface of the main duct or trunk line is also planar. The flange could also be curved in shape if the main duct or trunk line also has a curved shape or made to be rectangular or square in shape rather than round as illustrated below. The flange could also include adhesive, e.g., an adhesive tape, on a flange face to facilitate a sealing attachment to main or branch line, the adhesive adhering to the surface of the main or branch line. Fasteners can also be used to further attach the flange to the main or branch line.

The outlet of the take off is often cylindrical in shape and intended to be inserted into one end of a flexible duct, with the flexible duct attached to the cylindrical end using conventional means, e.g., ties, mastic, tape, and combinations thereof. The other end of the flexible duct then connects to a register box or some other kind of HVAC connector with the ultimate goal of supplying conditioned or unconditioned air to a space in the building or structure having the main line or trunk lines as a part thereof.

Take-offs can also be designed with a damper assembly as a part thereof. FIG. 1 shows a typical take-off using a damper assembly, the take off designated by the reference numeral 10. The take off 10 includes a frame or housing 1. A damper mechanism is designated by the reference numeral 3 and includes a blade or plate 5, a rod 7, and control arm portion 9. In this embodiment, the rod 7 is held by bearings 11, each bearing mounted in the housing 1. However, the bearings could be optional and the rod 7 would pass through openings in the housing for rotation thereabout. The plate 5 is attached to the rod using a bracket 13, but other means could be employed to attach the plate to the rod, e.g., spot welding, configuring the plate with an opening to receive the rod, or the like.

In FIG. 1, the control arm portion 9 is really an extension of the rod and allows the plate to rotate by movement of the rod. The rod could be I-shaped as well with the bend of the rod formed outside the opening in the housing for damper plate movement. The rod and control arm could also be two separate elements. For example, the rod could be square in cross section and the control arm could have a square shaped opening to attach to the square end of the rod for damper plate movement.

The take off of FIG. 1 is not shown with the typically-employed flange on one end thereof, but an example of such a damper-containing take off is shown in FIG. 2, wherein the take off is designated by the reference numeral 20 and includes a flange 21, outlet 23 for flexible duct connection, and damper assembly 25. The damper assembly is one that uses a separate control arm like that described above and includes a damper plate and a rod having the damper plate mounted thereto. Each end of the damper rod is mounted to the take off housing to allow pivotal movement of the damper plate. One of the connections of the damper rod and take off housing includes a control lever, movement of this level controlling the position of the damper in the take off housing, e.g. fully closed, fully open, or a position in between.

FIG. 3 shows another damper-containing connector that is designated by the reference numeral 30. In this connector, a box-type structure 31 is used as the inlet end of the connector 30, the outlet 33 still having the cylindrical shape to accommodate connection to a flexible duct. The structure 31 is also shown with flanges 35 to facilitate attachment of the connector to a main duct or branch line.

As can be seen from each of FIGS. 1-3, each end of the damper rod passes through an opening in the take off housing to allow rotational movement of the rod within the opening. The take off could also be designed so that one end of the damper rod fits into a dimple in the take off housing, the one end rotating in the dimple, with the other end of the damper rod passing through an opening in the housing for the control arm and damper operation. With the dimple, there is only one opening in the take off housing.

One problem with the prior art take offs/connectors is that they are prone to leakage at the connection between the damper rod and the take off housing. With the aim to achieve ever better energy efficiency in HVAC systems in buildings, these kinds of take offs and their prominent leakage of the conditioned air traveling through the take off is detrimental to the goal of improved energy savings for building construction.

In the field, these leaks are addressed by an installer covering up the openings with tape or the like. Additionally, the entire take off is regularly covered with insulation and a vapor barrier to prevent heat loss and condensation due to differences in the internal and external temperatures of the take off housings. While this solves the leakage and insulation problem, the installers also end up covering up at least a portion of or the entirety of the control arm, thus effectively rending the damper inoperable by limiting the ability to change the position of the damper.

In light of the problems with these kind of damper-containing take offs/connectors, a need exists to provide a damper-containing take off/connector that has minimal or no leakage through the take off housing while also providing sufficient insulation so as to improve the efficiency of the HVAC system while at the same time allowing for damper operation. The present invention responds to this need by providing a damper-containing connector that includes foam insulation surrounding at least a portion of the connector housing, the foam insulation providing better sealing of openings in the take off housing. The foam insulation also provides additional improvements in terms of both maintaining a sealed connector while, at the same time, keeping the control arm exposed so that the damper can still be moved to a desired position for air flow control. The foamed insulation also offers the opportunity to enhance the seal between a flexible duct and either the outlet or housing of the connector and provides the added benefit of providing an insulating effect for the take off itself.

### SUMMARY OF THE INVENTION

A first object of the invention is to provide an improved HVAC connector that minimizes the leakage associated with the connector when the connector includes a damper assembly that necessitates the existence of one or more openings in the housing of the connector, such openings allowing leakage of conditioned air passing through the connector.

Another object of the invention is to provide an improved method of moving conditioned or unconditioned air into a building space, the improvement entailing use of the inventive damper-containing connector.

Other objects and advantages will become apparent with the detailed description of the invention.

In one embodiment, the invention relates to a damper assembly-containing connector that includes a housing with an inlet and an outlet. The damper assembly is designed to control air flow through the housing and it includes a damper rod mounted in at least one opening in the housing of the connector, the damper rod having a damper plate attached thereto. One end of the damper rod includes a control arm configured to move the damper plate between a fully open position, a fully closed position, and positions therebetween.

The connector also includes a layer of foam insulation covering at least a portion of the housing having the at least one opening for the damper rod. An end portion of the damper rod extends through the foam insulation layer with the control arm positioned in a first surface profile of the foam insulation surrounding at least a portion of the housing and held in a first operating position, the surface profile allowing the control arm to be moved to a second operating position.

In another embodiment, the foam insulation can be configured to facilitate attachment with a duct at the outlet of the connector. The outlet of the connector can have a cylindrical or square/rectangular shape with the foam insulation surrounding at least a portion of the outlet. The foam insulation arranged at the outlet of the connector can include a plurality of crushable ribs or a crushable foam insulation layer extending around an outer surface of the outlet as a second surface profile. The crushable ribs or crushable foam insulation layer is configured to receive a means for attaching a flexible duct to the outlet, crushing of the crushable ribs or crushable foam insulation layer as part of attaching the flexible duct to the outlet enhancing a seal between the flexible duct and the outlet. Preferably, the second surface profile includes the crushable ribs.

The foam insulation layer surrounding the housing can also include another set or plurality of crushable ribs as a third surface profile. This third surface profile is also configured to receive a means for attaching a flexible duct to the foam insulation surrounding the housing as opposed to an attachment between a flexible duct and the outlet of the connector. As with the second surface profile, crushing of the crushable ribs layer as part of attaching the flexible duct to the foam insulation covered housing enhances a seal between the flexible duct and the housing.

While the foam insulation can be any known type, a preferred insulation is a polyurethane foam.

For some connectors, the inlet of the connector can include a flange that facilitates attachment of the connector to a duct, e.g., a main line or branch line duct.

While the first surface profile can have different configurations to hold the control arm in a desired position, one position includes a recess formed in the foam insulation surrounding the housing. The recess can be either formed in the surface of the foam insulation surrounding the portion of the housing as the first surface profile or, in an alternative configuration, the first surface profile can include a first raised portion of the foam insulation, the first raised portion extending from the surface of the foam insulation layer surrounding the portion of the housing and including the recess.

When the recess is positioned in the first raised portion of the first surface profile, the first surface profile can include at least one second raised portion positioned adjacent the recess, preferably a pair of second raised portions, each positioned adjacent the recess. The one or more than one second raised portions have a surface for engaging the control arm when moved from the recess to the second operating position.

The first surface profile can include a stop to restrict movement of the control arm once removed from the recess. The stop can extend from a surface of the foam insulation layer if the recess is positioned in the foam insulation surrounding the housing or the stop can be configured so that it extends sufficiently from the foam insulation surface to restrict movement if the recess is positioned in the first raised portion of the foam insulation layer.

While the connector can have virtually any configuration that includes an inlet and outlet with the damper assembly positioned therebetween, the connector can have an inlet and outlet that are similarly shaped. Alternatively, the connector can be configured like a conventional take off, with its inlet configured with a flange that engages the surface of a duct like a main duct line or branch duct line and its outlet configured to connect to a flexible duct.

The foam insulation surrounding the housing can also be further configured with a lip that extends along a periphery of the foam insulation layer at the inlet. This lip extends from a surface of the foam insulation and is intended to engage a duct for inlet attachment of the connector. The lip provides an additional sealing function for the connection between the inlet of the connector and an opening in a duct that would supply conditioned or unconditioned air to the connector.

While the connector can be supported by its engagement between a duct and the inlet, wherein the duct is supported itself, the connector could also include means for supporting the connector itself rather than relying on a duct or other HVAC connector for support. For example, if the damper assembly-containing connector links a pair of ducts, the connector may need support, such support being any conventional type that is used in the HVAC field, straps, brackets, etc.

Besides providing a damper assembly-containing connector that can be used in any kind of an HVAC system to provide control over air flow, the invention also includes using the damper assembly-containing connector in a method of moving conditioned or unconditioned air in a building or structure. Any of the variations of the connectors described above can be utilized, whether it be like a conventional take off, a connector linking a pair of ducts, or a connector supplying a register box.

### BRIEF DESCRIPTION OF THE DRAWINGS

FIG. 1 shows an example of a prior art HVAC connector that employs a damper for control of air flow through the connector.

FIG. 2 is another example of a prior art take off having a damper as a part thereof.

FIG. 3 is yet another example of a prior art take off having a different configuration for linking with a main duct or branch line of an HVAC system.

FIG. 4 shows a bottom perspective view of an exemplary connector for use in the invention without the foam insulation.

FIG. 5 shows a top perspective view of an uninsulated connector of FIG. 4.

FIG. 6 is a side perspective view of the connector of FIG. 4 with added foam insulation and the surface configuration of the foam insulation that interfaces with the damper control arm of the damper assembly of the uninsulated connector.

FIG. 7 shows an inlet end or bottom view of the insulated connector of FIG. 4.

FIG. 8 shows a sectional view along the line 8-8 of FIG. 7.

FIG. 9 shows another sectional view of the insulated connector of FIG. 6.

FIG. 10A shows an enlarged view of a part of the inventive take off showing the foam insulation surface profile and crushable ribs for duct attachment.

FIG. 10B shows a sectional view of the surface profile of FIG. 10A.

FIG. 10C shows a sectional view of another kind of surface profile for the control arm of the damper assembly of the connector.

FIG. 11 is a top view of the insulated connector of FIG. 4 in line drawing form.

FIG. 12 is a top perspective view of the insulated connector of FIG. 4.

FIG. 13 is a side view of the insulated connector of FIG. 4 showing the insulation surface profile for the control arm.

FIG. 14 is another view of the insulated connector of FIG. 4.

FIG. 15 shows an enlarged view of the detail B of FIG. 14.

FIG. 16 is a cross section along the line A-A of FIG. 14.

FIG. 17 is an enlarged portion of the detail C of the bottom of the insulated connector of FIG. 16.

FIG. 18 is an enlarged portion of the detail D of outlet of the insulated connector of FIG. 16.

FIG. 19 is a sectional view of the sealing means using crushable ribs on the outlet of the insulated connector of FIG. 6.

FIG. 20 is a sectional view of a crushable layer of foam insulation as an alternative to the crushable ribs of FIG. 19.

FIG. 21 is a sectional view of the attachment arrangement between a flexible duct and the sealing means of FIG. 19.

FIG. 22 are sectional views of different configurations of the crushable ribs of FIG. 19.

FIG. 23 is a sectional view of crushable ribs showing dimensional aspects thereof.

FIG. 24 is a schematic drawing of another embodiment of the insulated connector or the invention.

FIG. 25 is a schematic drawing of yet another embodiment of the insulated connector of the invention.

### DETAILED DESCRIPTION OF THE INVENTION

The inventive insulated connector offers significant advantages in the field of moving conditioned or unconditioned air in buildings or other structures when the HVAC system requires the use of dampers for air flow control. Prior art connectors that include a damper assembly, for example, take offs, have significant leakage problems or the damper assembly is rendered inoperable when an installer would apply tape or insulation over or cover the damper assembly control arm in some way to seal the air leakage and prevent heat loss. Covering the opening where the control arm is located interferes with the movement of the control arm and any advantage that the damper assembly provides in terms of air flow control is lost as a result of trying to mitigate the leakage and heat loss associated with the damper assembly.

With the inventive connector, a layer of foam insulation is formed around at least a portion of a housing of a take off or other type of HVAC connector, where one or more openings exist for the damper rod mounting. This foam insulation effectively fills the one or more openings in the take off/connector housing that exist to allow the damper rod to be mounted to the housing for damper rotation. While the foam insulation effectively fills the openings in the housing, the nature of the foam and its adherence to the damper rod is such that rotational movement of the rod applies a sufficient force that the rod can still freely rotate against any foam located in the one or more openings. While there still may be space between the rod outer surface and foam insulation filling the opening, this space is minimal at best and the presence of the foam insulation in the one or more openings in the housing still effectively minimizes leakage of air through the opening.

As explained in more detail below, the presence of the foam insulation also provides a means to allow the control arm for the damper assembly to remain exposed for operation thereof and be held in a desired position depending on whether the damper is to be fully open, fully closed, or positioned between these two states.

Another advantage of employing the layer of foam insulation on the housing of the connector is the ability to configure the foam insulation on an inlet, outlet, or both to provide a sealing means that enhances any seal associated with an end portion or outlet of the insulated connector or housing thereof and a duct, whether the duct is associated with the inlet or outlet of the insulated connector.

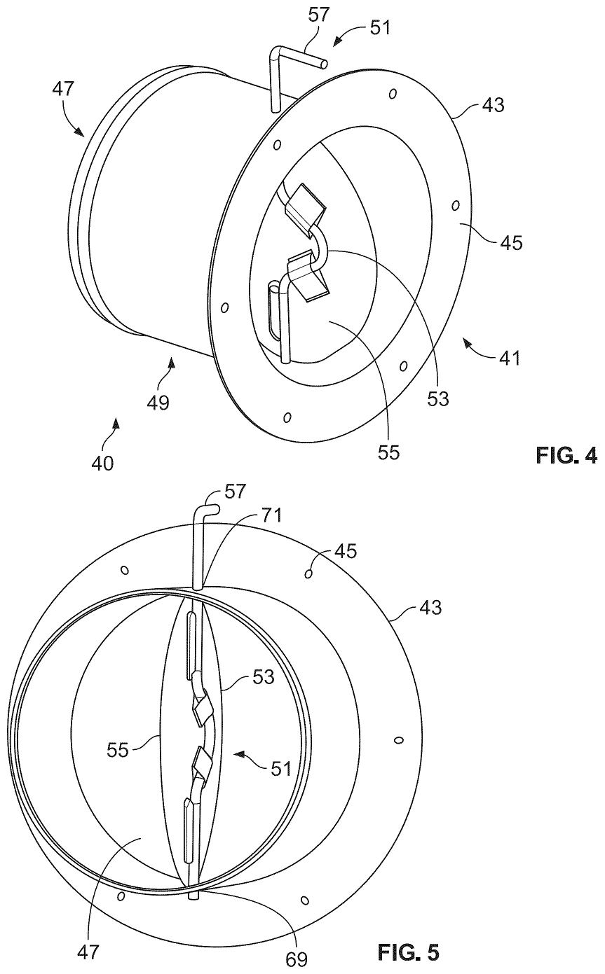

Referring now to FIGS. 4 and 5, an insulated connector is shown in this embodiment as a take off, but the connector can have other configurations as detailed below. Hereinafter, this take off is referred to as a connector for description purposes as aspects of the invention can be used with other kinds of damper assembly-containing connectors. The connector is part of the invention when a foam insulation, e.g., a polyurethane foam, is applied to the connector. In this embodiment, the connector is configured as a conventional take off and designated by the reference numeral 40. The connector 40 includes an inlet end 41 having a flange 43 intended to connect to a main duct or branch line (not shown). The flange 43 can use any known means for attaching to the main duct or branch line, e.g., adhesive tape, fasteners, adhesives, or combinations thereof. In this embodiment, the flange includes openings 45 to facilitate attachment to a given structure, e.g., a main duct or branch duct line. The flange shape is exemplary and the shape shown in FIGS. 4 and 5 is flat shape to attach to a planar or flat surface of the main duct line or branch line. The flange could also have a curved shape to allow attachment to a main duct or branch line having a cylindrical shape.

The connector 40 includes an outlet 47 intended to connect to a flexible duct, not shown. An example of this attachment would be for the insertion of an end portion of the outlet 47 into a flexible duct. The outlet 47 is cylindrical in shape but can also be square in shape.

The connector 40 also includes a housing 49, the housing 49 supporting a damper assembly designated by the reference numeral 51. The damper assembly includes a damper rod 53, a damper plate 55, and a control arm 57. While the control arm 57 and damper rod 53 are shown as one integral member for supporting the damper plate and mounting to the housing, the control arm 57 and damper rod 53 can be separate elements and be connected using any conventional attachment technique known in prior art take off designs.

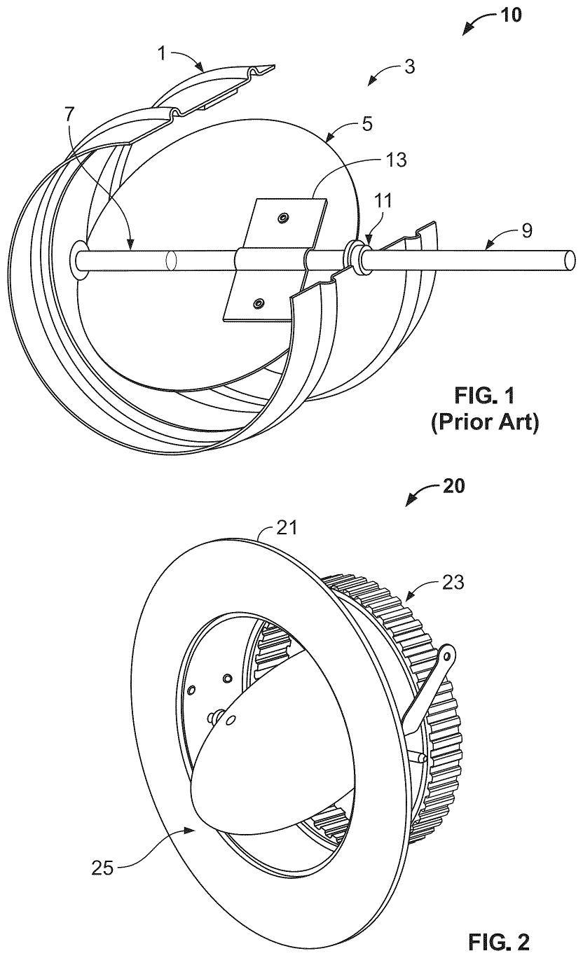

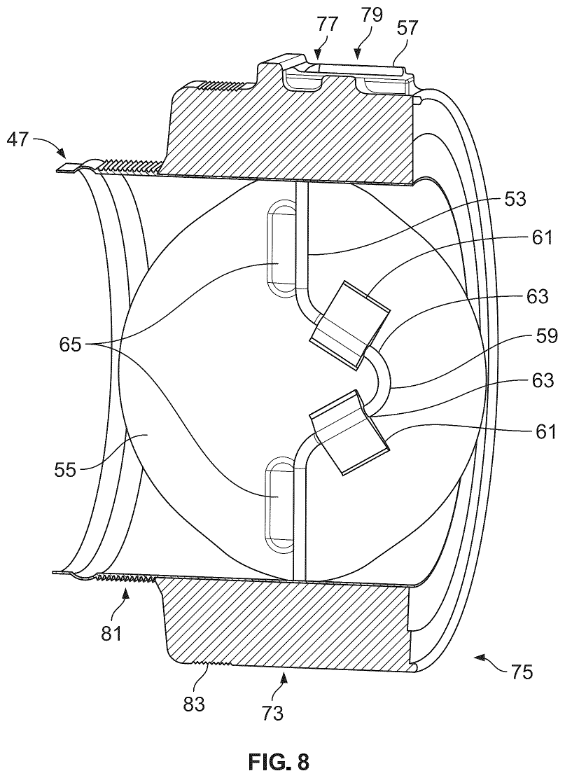

The damper plate 55 can be attached to the damper rod in virtually any way, welding, mechanical fastening, the use of clips on the damper plate to engage the damper rod, combinations thereof and the like. In the illustrated embodiment and referring to FIG. 8 for the best illustration of the means of attaching the damper rod 53 to the damper plate 55, the damper rod 53 includes a U-shaped bent portion 59. Brackets 61 are attached to the damper plate, e.g., by spot welding, legs 63 of the U-shaped portion 59 positioned between the brackets 61 and a surface of the damper plate 55. Stops 65 are provided on the damper plate 55, the stops 65 positioned against straight portions 67 of the damper rod 53. The manner of connection of the damper rod 53 to the damper plate 55 is just an example and other means for attaching the damper rod to the damper plate can be used, see FIG. 1, wherein a support bracket is used and FIG. 2, wherein the damper rod is made up of two pieces, one piece for mounting to the housing and the other piece having the control arm.

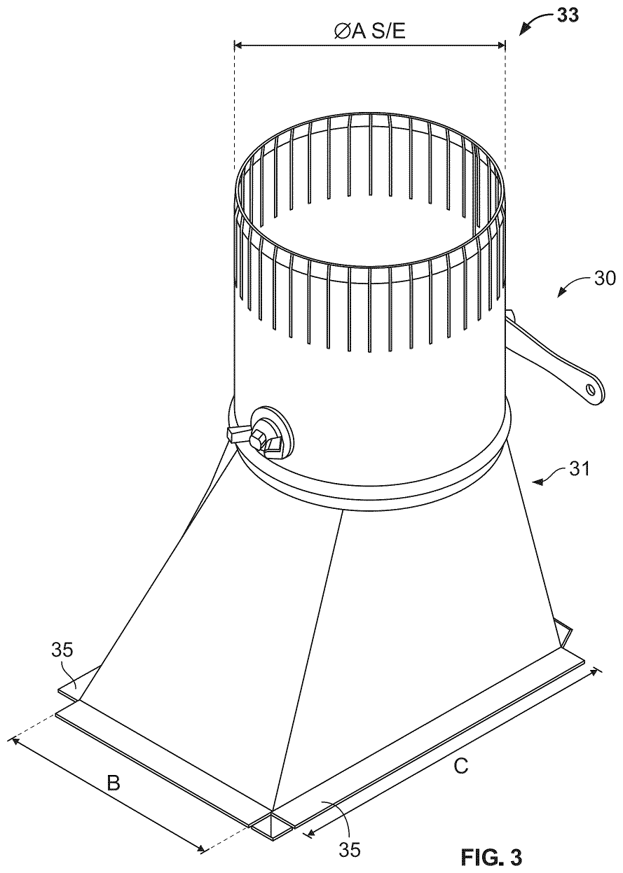

Referring back to FIGS. 4 and 5, the damper rod 53 is shown mounted in opposing openings 69, 71 in the housing 49 to allow rotational movement of the damper rod 53 with respect to the housing 49. One end of the damper rod passes through opening 69. Another portion of the damper rod 53 passes through the other opening 71, the damper rod 53 terminating from this other portion at the control arm 57. Other arrangements can be used to connect the damper rod 53 to the housing 49 and allow rotation of the damper rod 53 with respect to the housing 49. For example, the dimple arrangement described above could also be employed to secure the end of the damper rod 53 opposite to the control arm 57 to the housing. While this arrangement leaves only one opening in the housing for sealing purposes, having two openings in the housing for support of the damper rod 53 is preferred as this mounting arrangement is more robust and less likely to fail. The manner in which the end of the damper rod opposite to the control arm is mounted in the housing opening can be any know type, e.g., the bearings of FIG. 1, the use of a fastener arrangement as shown in FIG. 3, or the arrangement of FIGS. 4 and 5, wherein the damper plate is positioned in the housing such that the damper rod is basically held in place and cannot translate along an axis thereof such that the non-control arm end could disengage from the opening 69 in the housing 49. Since this attachment is essentially a permanent one for the damper assembly, this entire attachment arrangement can be covered by the foam insulation layer as described in more detail below.

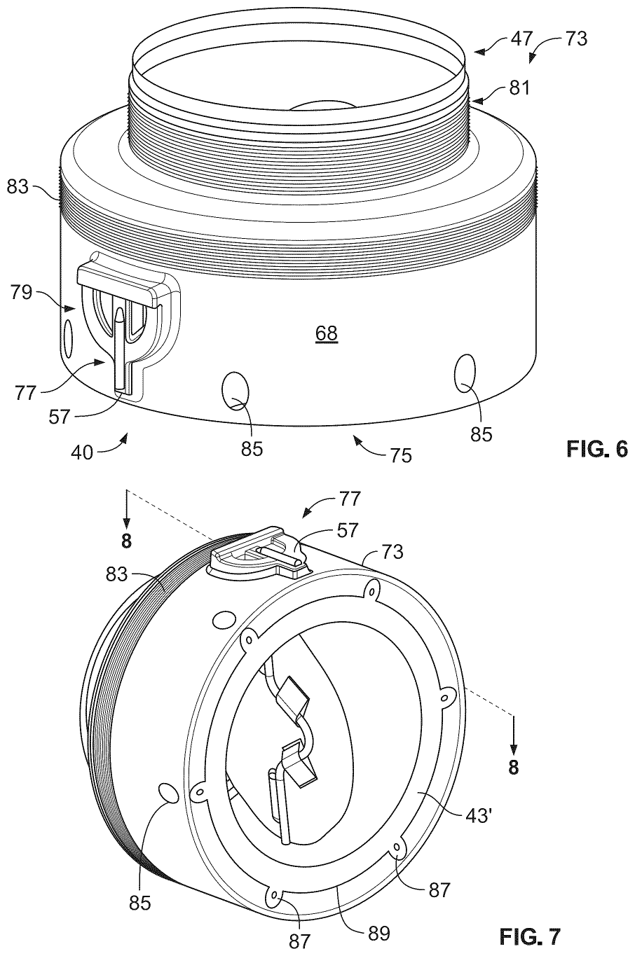

Referring now to FIGS. 6-8, the connector 40 has a foam insulation layer 73 covering the housing 49 (not visible) and a portion of outlet 47 of the connector 40, leaving a portion of the outlet 47 of the connector 40 exposed. The combination of the connector 40 and foam insulation 73 forms an insulated connector 75, the foam insulation layer surrounding the housing 49 and including a surface 68. The foam insulation 73 of the insulated connector 75 includes a raised portion 77 that extends from the surface 68. This raised portion 77 has a particularly configured surface profile 79, which is designed to interface with the control arm 57 for its positioning and is described in more detail below.

The foam insulation 73 covering the connector outlet 47 includes a second surface profile that is designated by the reference numeral 81, the second surface profile 81 is associated with the end portion of the outlet 47 to enhance the sealing of a flexible duct to the outlet 47. The foam insulation layer covering the housing 49 can also include a third surface profile 83, which can also be used to enhance sealing when a duct should be needed to attach to the foam insulation layer-covered housing rather than the outlet 47. The second and third surface profiles are described in more detail below.

The foam insulation layer 73 also includes through holes 85, which allow for access to the openings 45 in the flange 43 of the connector 40, see FIGS. 4 and 6. The through holes 85 are optional as the flange 43 could be made with an annular width that would exceed the thickness of the foam insulation layer 73. The portion of the flange extending beyond the foam insulation layer 73 could have through holes in it for insulated connector attachment to a given duct.

FIG. 7 shows an alternative design to the flange 43 of FIG. 4. Instead of an annular flange that includes the openings 45 for attachment of the insulated connector 75 to a duct line, a flange 43′ is shown that is still generally annular in shape. The width of the flange 43′ is reduced as compared to the flange 43 of FIG. 6 and through-hole containing protrusions 87 are provided that extend from a peripheral outer edge 89 of the flange 43′. Through holes 89 of the protrusions 87 align with the openings 85 in the foam insulation layer 73 for insulated connector attachment purposes.

FIGS. 8 and 9 show different sectional views of the insulated connector 75, showing that the surface profile 81 has a minimal thickness of foam insulation at the outlet 47 and the insulation layer covering the housing 49 of the insulated connector 75 has a much greater thickness for overall insulation purposes and providing the means to allow the damper control 57 to be operated while sealing any openings in the housing related to the damper assembly 51.

The use of the foam insulation layer 73 surrounding the housing 49 accomplishes several things. First, the foam insulation 73 covers or seals the openings 69, 71, see FIG. 5, that provide a leakage path between the interior space of the housing 49 and the outside. For the opening 69 in the housing 49 that is opposite to the side having the control arm 57, the foam insulation layer 73 can completely cover this arrangement as this fastening arrangement of the damper rod 53 to the housing 49 is intended as a permanent arrangement that does not need access as would the control arm 57 of the damper assembly 51.

At the same time of providing a sealing function for the openings 69 and 71 in the housing 49, the layer of foam insulation 73 also allows the control arm 57 to be exposed for manipulation and control of air flow through the insulated connector 75. This avoids the problem of the prior art wherein the control arm is usually covered with tape to seal the opening in the housing but then the control arm cannot be used for its intended purpose

While the foam insulation is shown as formed as a layer on essentially the entire housing 49, it could be possible to layer the foam insulation just in the vicinity of the openings 69 and 71 and leave other areas of the housing uncovered. However, it is preferred that the foam insulation cover as much of the housing 49 and outlet 47 as possible as this improves the insulating value of the housing during use. It also makes the process of forming the layer of foam insulation easier as the molding is less complicated.

Referring back to the raised portion 77 and its surface profile 79 of FIGS. 8 and 9 and the ability to leave the control arm exposed while at the same time sealing the opening 71 in the housing, this first surface profile 79 of the layer of foam insulation also provides a means to control the position of the control arm 57.

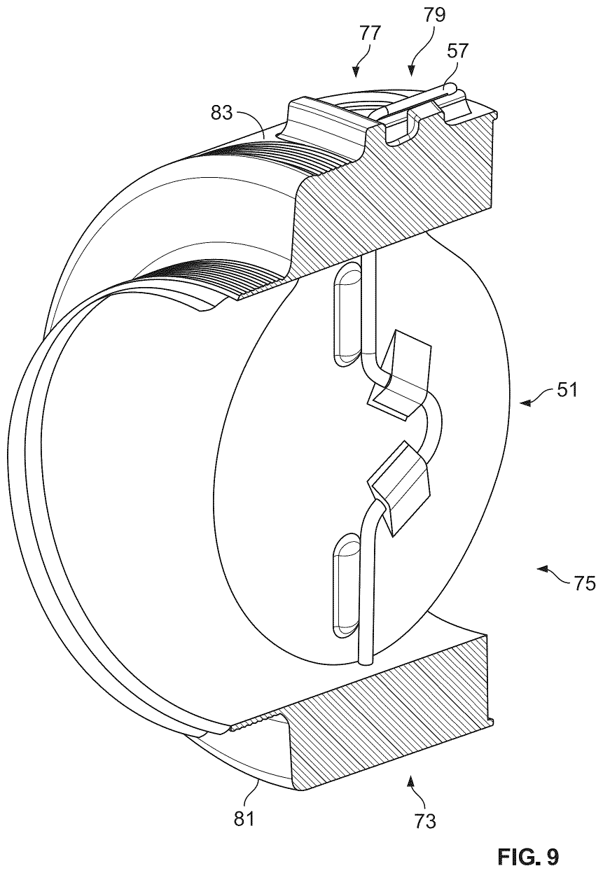

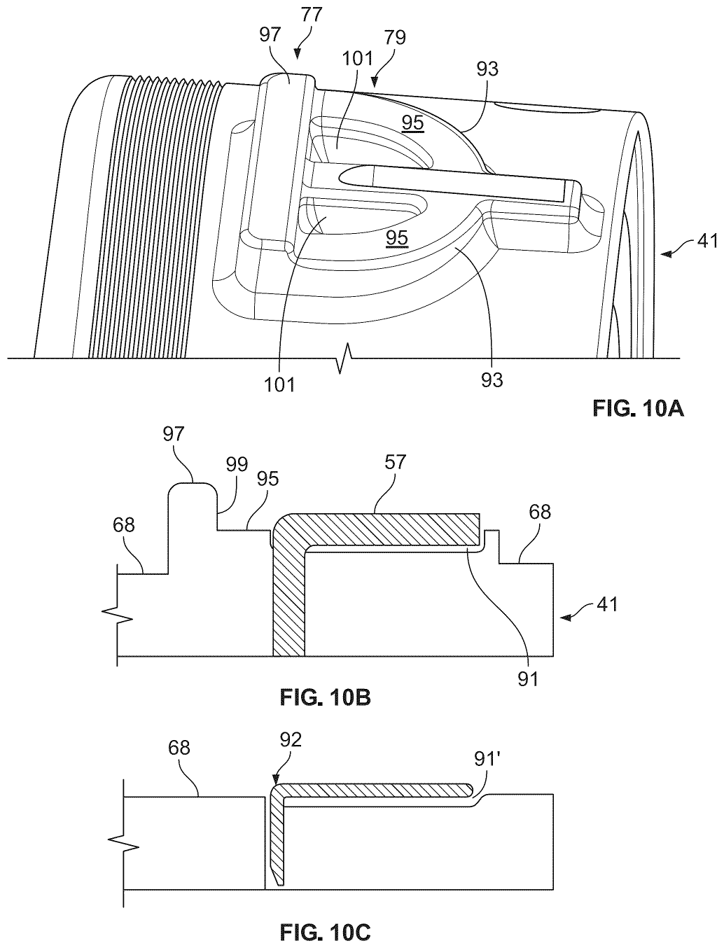

The surface profile 79 of the raised portion 77 as shown in the sectional views of FIGS. 8 and 9 is shown in greater detail in FIGS. 10A and 10B. FIG. 10B is a sectional view through the middle of the control arm to show how the control arm interfaces with the surface profile 79. Here, the surface profile 79 includes a recess or groove 91 that is configured to receive the control arm 57 in a default position for the damper plate assembly 51. In this embodiment, the default position is having the damper fully open. However, the recess could be positioned as part of the surface profile so that the default position is the fully closed position or a position between fully opened and fully closed. Since the control arm 57 fits in the recess 91, walls of the recess keep the control arm in default position absent some application of outside force to move the control arm 57.

The surface profile 77 also includes a pair of raised portions 93, the raised portions 93 extending from the surface 68 of the foam insulation layer 73 and positioned on either side of the recess 91. Each raised portion 93 includes a surface 95. A stop 97 is also provided as part of the raised portion 77 and surface profile 91. The raised portions 93 are sized with respect to the control arm 57 such that if the control arm 57 is moved out of the recess 91 from its at rest state, a portion of the control arm 57 comes into contact with one of the surfaces 95, the one surface depending on the direction of movement of the control arm 57 of the raised portion. This contact provides sufficient friction between a portion of the control arm 57 and the surface 95 to maintain the control arm 57 in the position different from the default position created by the recess 91. With the recess 91 configured to align the damper plate 51 in the fully open position, the surface profile is shown with two raised portions 93 so that a user of the damper assembly can move the control arm in either direction from a default position to achieve a fully closed position or an intermediate position to allow a restricted amount of air flow.

The stop 97 with its face 99, functions to limit the travel of the control arm 57. While the stop 97 is shown as a continuous member extending from the surface 68 of the insulation layer 73, it could have different configurations, e.g., a pair of spaced apart upstanding members, each with a face to engage the control arm 57.

The raised portions 93 are shown with a curved configuration to allow for travel of the control arm from the default position for at least 90 degrees. With the control arm in the recess 91 and in the fully open position, the control arm 59 would be rotated 90 degrees and the raised portion 93 would provide the necessary frictional contact with the control arm to keep the control arm in place. The curved raised portions are only exemplary and the raised portions 93 could have other shapes. For example, instead of having recesses 101, which are positioned between the control arm 57 and raised portions 93, the raised portions 93 and their surfaces could occupy the space of the recesses, thus creating a larger surface area for the control arm 57 to travel over when being moved from the default position. However, it is believed that the more limited surface area provided by the raised portions 93 is sufficient to hold the control arm 57 in place if moved from the default position.

While two raised portions 93 of the raised portion 77 are preferred so that the control arm 57 can be moved in either direction from the default position, only one raised portion 93 could be formed as part of the raised portion 77 and its surface profile 79.

In an alternative embodiment, the foam insulation layer could be formed with a different surface profile as compared to the one shown in FIGS. 10A and 10B, wherein the control arm 57 rests in the recess 91, and a bottom of the recess 91 is raised from the surface 68 of the foam insulation layer. FIG. 10C shows such an alternative wherein another surface profile has the recess 91′ is formed in the surface 68 of the foam insulation layer 73. In this embodiment, it is believed that with the control arm 57 in its at rest state in the recess 91′, with the housing and foam insulation layer thereon being cylindrical, once the control arm 57 is moved from the recess 91′, there would still be sufficient frictional contact between the elbow portion 92 of control arm 57 and the surface 68 of the foam insulation layer that the control arm would remain in a position removed from the recess 91′. If the housing were rectangular in shape, and the surface 68 would be flat where the recess 91′ is located rather than curved. In this embodiment, there would be more surface contact between the control arm 57 and surface of the foam insulation once the control arm 57 is moved from the recess so as to increase contact between the foam insulation and control arm and better maintain the control arm in a desired location. While the surface profile embodiment of FIG. 10C does not have as much frictional contact as the surface profile and raised portion of FIGS. 10A and 10B, it is believed that this embodiment still provides the necessary frictional contact to keep the control arm 57 in its desired place rather than by the surfaces 95 of the raised portions 93. Any of the configurations of FIGS. 10A-C provides a means for retaining the control arm is a first position using a surface profile of the foam insulation layer and permitting the control arm to be moved to another position and held therein, the other position including using a raised surface profile of the foam insulation layer or just a surface of the foam insulation layer. In another alternative embodiment, the foam insulation layer could be formed completely over the control arm 57 to ease molding of the foam. In this embodiment, the foam surrounding the control arm 57 could be very thin and easy to tear. In order to move control arm 57, the force applied to the control arm to move the damper plate assembly 51 would tear through the thin foam covering control arm 57 permanently.

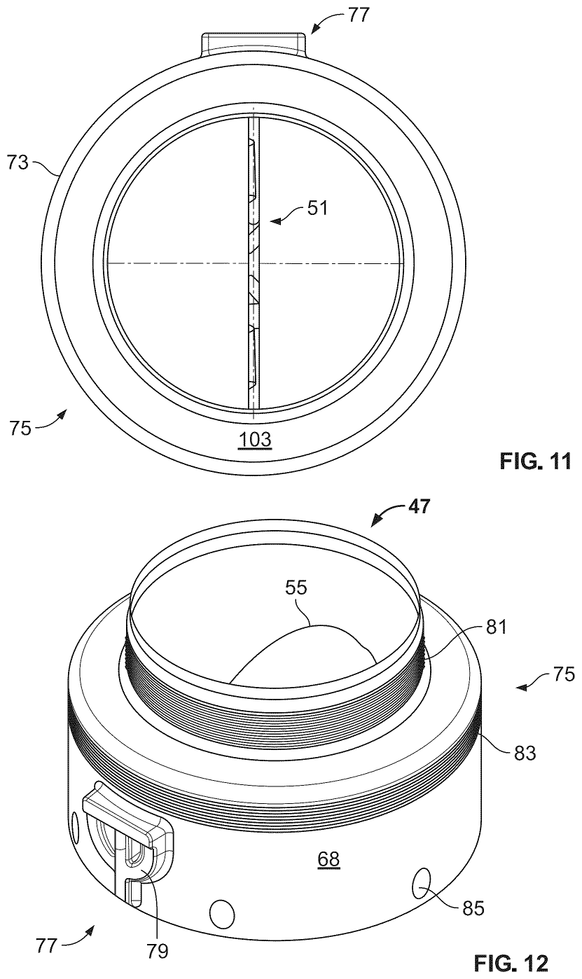

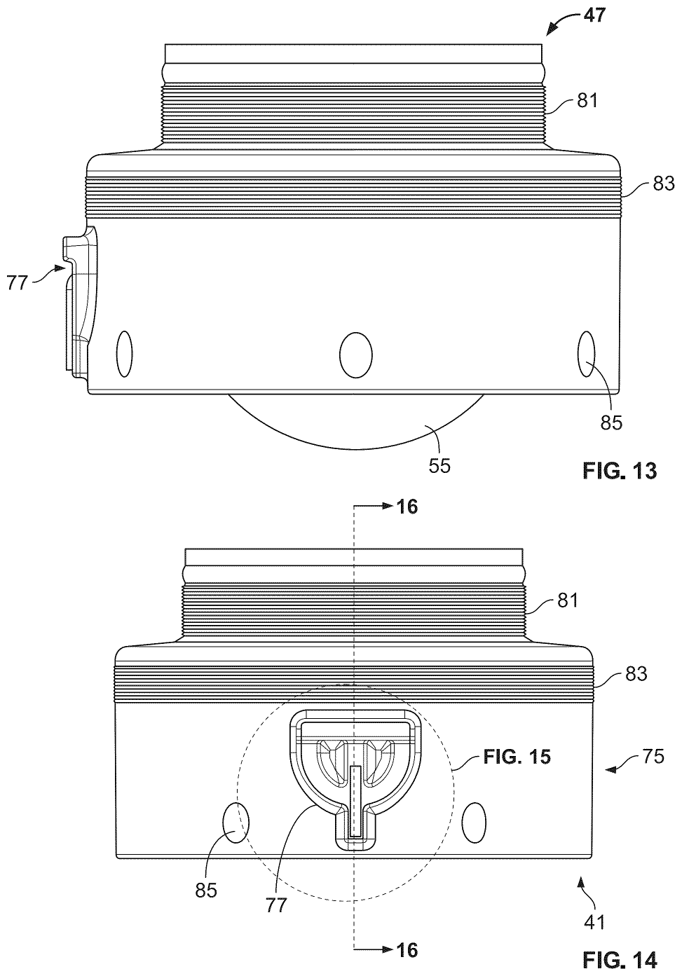

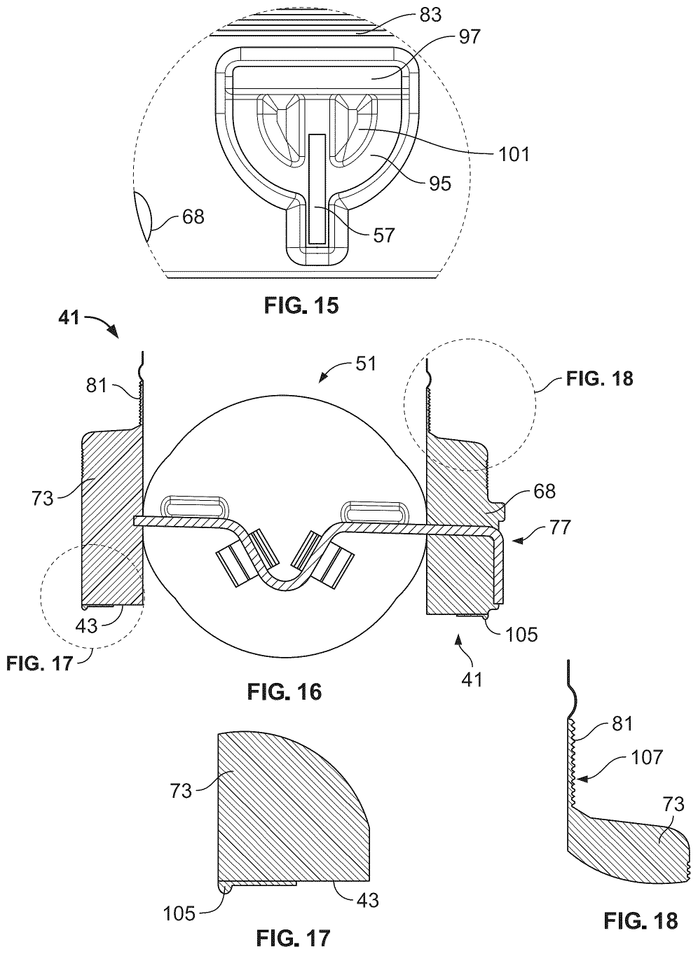

FIGS. 11-18 show line drawings of the insulated connector shown in FIGS. 4-10B. FIG. 11 shows a top view of the insulated connector 75 with the damper assembly 51 in the open position. This view also shows the surface 103 of the foam insulation layer 73 surrounding the housing 49 of the connector 40 and reveals the extent of the thickness of the foam insulation layer 73. The views of the insulated connector 75 in FIGS. 12-15 show the second and third surface profiles 81 and 83 as well as the raised portion 77 and its surface profile 79. As noted above, a duct can connect to the insulated connector using each of the surface profiles 81 and 83, with the surface profiles enhancing the seal between the insulated connector 75 and the duct.

Referring to FIGS. 16 and 17, another feature of the insulated connector is the use of a lip or bulb that extends along a peripheral edge of the foam insulation layer at the inlet end 41 of the insulated connector 75. This lip is designated by the reference numeral 105 in FIG. 16 and is formed as part of the foam insulation layer 73. The lip functions as a sealing member when the flange 43 is attached to a duct to provide communication between the inlet 41 of the insulated connector 75 and the duct. The lip 105 is formed outside of the periphery of the flange, where the flange is either the kind shown in FIG. 4 or the protrusion-containing smaller flange of FIG. 7, each flange interfacing with through holes in the foam insulation layer 73 for insulated connector attachment to a duct. If the insulated connector is the embodiment where the flange 43 would extend beyond the foam insulation so as to remove the need for through holes in the foam insulation layer, the lip 105 would not be used.

Besides the ability to better seal the connector at openings associated with the damper assembly, the foam insulation layer can also be configured to enhance the seal of a flexible duct to the outlet or inlet of the connector. The lip created by the foam insulation helps the seal at the inlet end of the insulated connector. The use of the second and third surface profiles 81 and 83 of the foam insulation layer 73 enhance sealing at the outlet 47.

It should be understood that one or both of the surface profiles 81 and 83 are optional as is the lip 105 and do not have to be used when the foam insulation layer 73 is used to better seal the housing for leakage but allow operation of the damper assembly 51.

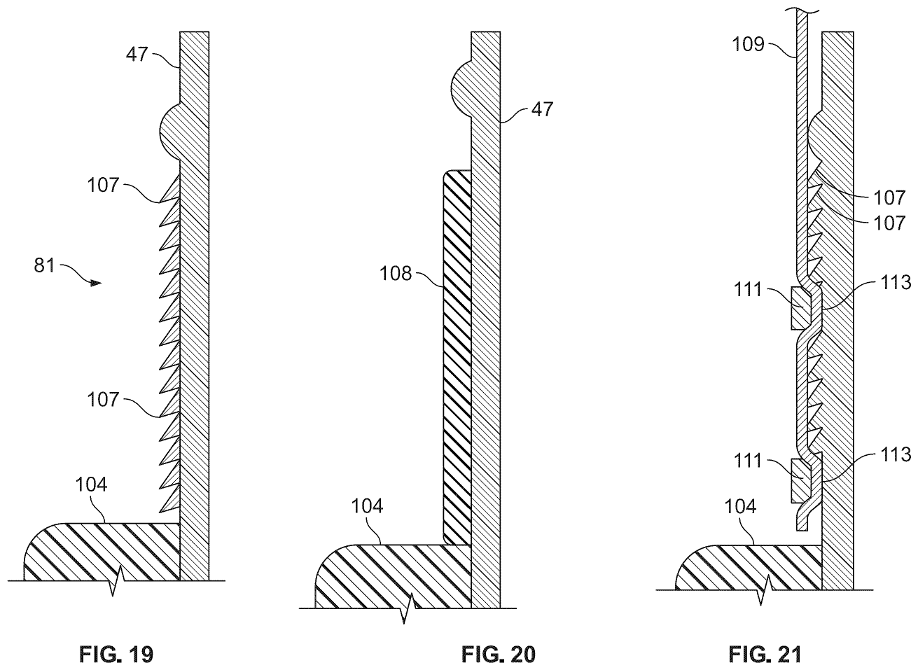

As illustrated above, the insulated connector has a cylindrically-shaped outlet 47 that is designed to be inserted into the open end of a flexible duct. When the foam insulation is formed as a layer on the housing of the connector, the foam layer can also be formed on at least a portion of the outlet 47 that would engage the flexible duct when attached to the connector, albeit with much less thickness. This foam layer is formed with crushable ribs or a crushable layer of foam, the ribs or layer surrounding the outlet 47. FIGS. 18 and 19 show a section of the outlet 47 with the crushable ribs 107 formed thereon and a surface 104 of the thicker portion of the foam insulation 73 surrounding the housing 49. FIG. 20 shows a crushable layer of foam insulation 108 as an alternative to the crushable ribs 107.

In FIG. 19, a plurality of ribs 107 run longitudinally along a length of a portion of the outlet 47, each rib also running circumferentially around the periphery of the outlet 47. The ribs 107 are shown as being generally triangular in cross section and are made of the same insulation that is used on the exterior of the housing 49 of the insulated connector 75.

With the ribs 107 as the polymeric foam molded onto the portion of the outlet 47, an installer can slide a flexible air duct liner (insulated or not) over the outlet 47. As part of this step, the vapor layer and insulation are peeled back, exposing the liner (not shown), with the liner ultimately in contact with the ribs 107 and outlet 47. With the vapor barrier peeled back to expose an outer surface of the liner, a zip tie can be used to secure the liner to the outlet 47 of the insulated connector. Since the cross sectional area of the ribs 107 is minimal, these ribs 107 would crush under the force of the zip tie application, the crushed ribs offering a better surface to maintain a seal between the liner and the outlet with its crushed ribs.

While the above technique includes an attachment wherein the zip tie is forced against the liner of an insulated air duct, the insulation, with or without the vapor barrier, could be left in place and the zip tie or ties could be applied against the liner/insulation/vapor barrier for attachment to the crushable rib-containing portion of the outlet 107.

The ribs 107 running circumferentially around the outlet 47 are shown evenly spaced along the length of the outlet 47, but can also include a number of ribs that intersect the circumferentially running ribs.

FIG. 21 shows a typical connection between a liner 109 of a duct and the outlet 47 of the insulated connector 75 that includes the ribs 107. A pair of zip ties 111 are used to secure the liner 109 to the outlet 47, with the zip ties 111 forming an area 113 of crushed ribs 107. While a pair of zip ties are used, one zip tie or more than two could be used. One zip tie could be used that would have a combined size equal to the two depicted in FIG. 21.

As an alternative to the use of the crushable ribs 107, the foam insulation could be in the form of just a layer 108 as shown in FIG. 20, the layer 108 having a thickness less than the thickness of the foam insulation layer 73 used to seal the openings in the housing that are associated with the damper assembly. The same crushing action as shown in FIG. 21 would be achieved when zip ties or other clamping mechanisms are arranged to apply a force to the foam layer 108 and outlet 47. While the crushing action is slightly different as there are no ribs nor spaces between ribs, the crushed foam still provides a better seal as compared to a liner being attached to the bare metal of the outlet.

While the foam layer is shown as a replacement for the ribs, the two kinds of crushable structures could be combined if so desired for the connector.

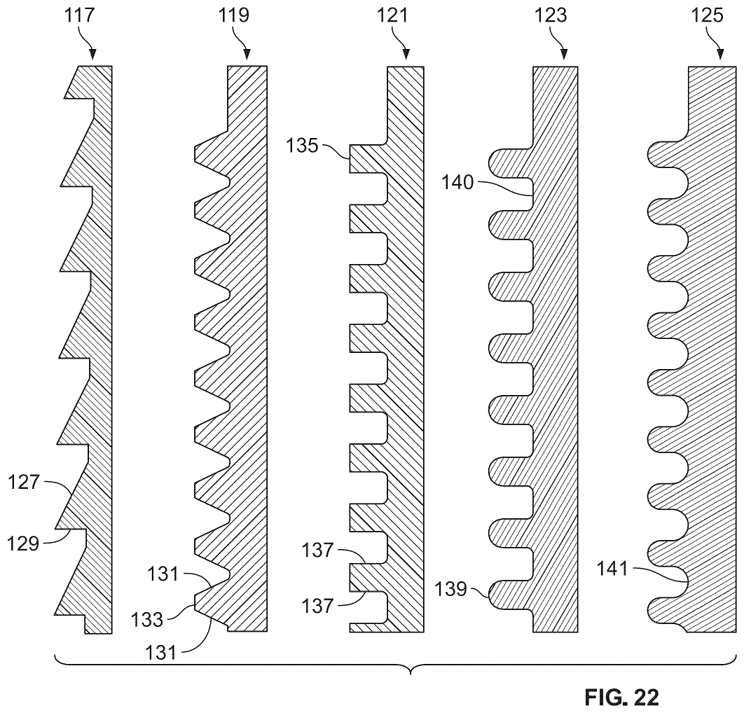

While the ribs 107 are shown with a generally triangular cross section, other shapes could be employed as along as the ribs are still crushable under the force of a zip tie to achieve properties for securing a vapor or moisture barrier to outlet 47. Rather than peaks like those found in series of triangular-shaped ribs, the profile of the ribs could take the form of a sine wave, with the outermost portions of the ribs being rounded off. The ribs could have a stepped configuration as well, wherein the ribs would be square or rectangular in cross section. FIG. 22 shows examples of different profiles for the crushable ribs. The different profiles are designated by the reference numerals 117, 119, 121, 123, and 125. Profile 117 is similar to the profile of the ribs 107 shown in FIG. 19, wherein the two exposed sides 127 and 129 of the ribs 107 are analogous to the hypotenuse and short side of a right triangle. The profile 119 is shaped more like a truncated cone in cross section, with the angled sides 131 of the ribs terminating in a flat top 133. The profile 121 also employs a flat top 135, but the sides 137 are generally perpendicular to the flat top 125 rather than being angled as shown in profile 119, thus forming more of a stepped profile. The profile 123 is similar to that of profile 121 but, instead of employing a flat top 135, the top 139 is rounded. In profile 123, the groove has a flat configuration 140 as opposed to the v-shaped groove shown in profile 119 for example. Profile 125 differs from profile 123 in that the groove 141 has a u-shape as opposed to the flat shape 140 in profile 123 or the v-shape of the groove in profile 119. Again, these profiles are exemplary and others could be employed to achieve the crushing feature of the ribs for seal enhancement between the register box and component parts of a duct.

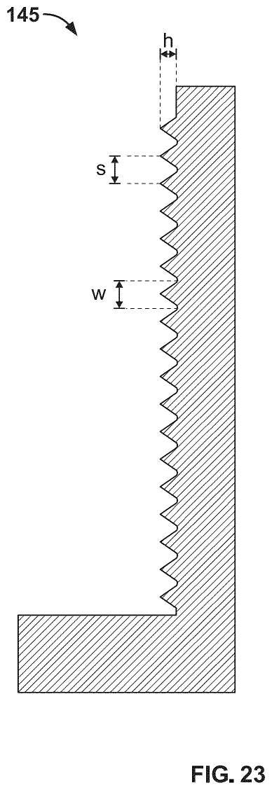

The various profiles of the ribs 107, i.e., having a series of peaks, the peaks being rounded, flat, or pointed, with grooves positioned between adjacent peaks, the grooves being flat, v-shaped, or u-shaped for example, create a series of spaces between the ribs that allow the ribs to be crushed and reduced in size by the force of a clamping mechanism like a zip tie applied against the ribs when securing a duct liner or vapor barrier to the register box. The depth of the grooves or height of the peaks, the spacing of the ribs, and the width of the ribs do not need to be excessively large to provide a crushable structure and rib heights, rib spacings and rib widths of less than an inch should provide a sufficiently small cross sectional area of foam so as to form a crushable structure to assist in the securement of a duct liner/vapor barrier to the register box. FIG. 23 shows an exemplary sinusoidal type profile 145 that identifies the ribs in terms of a height (h), rib spacing(s), and rib width (w). Preferred dimensions for rib height would range from 0.010 to 0.200 inches. Preferred dimensions for rib spacing would range from 0.020 to 0.250 inches. Preferred dimensions for rib width would range from 0.010 to 0.200 inches.

While any known method can be used to produce the foam layer on the connector, including the crushable ribs or layer if included, a preferred method is a molding method, wherein the mold is configured to create the surface profile for the insulation layer in the vicinity of the control arm to allow the control arm to be both held in place and moved, if desired. Similar, the mold would be configured to form a thinner layer of insulation around the outlet, the thinner layer having the crushable ribs or just as a layer for flexible duct attachment.

While the ribs 107 are shown to run circumferentially around the outlet 47 with adjacent ribs running generally parallel to each other, the ribs be slightly angled when running along the circumference of the outlet if so desired. Further yet, the ribs could intersect with each other as well when covering a circumference of the outlet 47 of the connector.

The third surface profile 83, see FIG. 6 for example, can have the same rib configuration as shown for the outlet 47. Having the ribs 107 on the surface 68 of the foam insulation layer offers another attachment option for an installer working with the insulated connector 75. That is, instead of using the outlet 47 as a means for connecting to a duct, the third surface profile 83 on the foam insulation layer 73 can be employed for duct connection, with the connection being achieved in the same manner as described above when connecting a duct to the second surface profile 81 at the outlet 47.

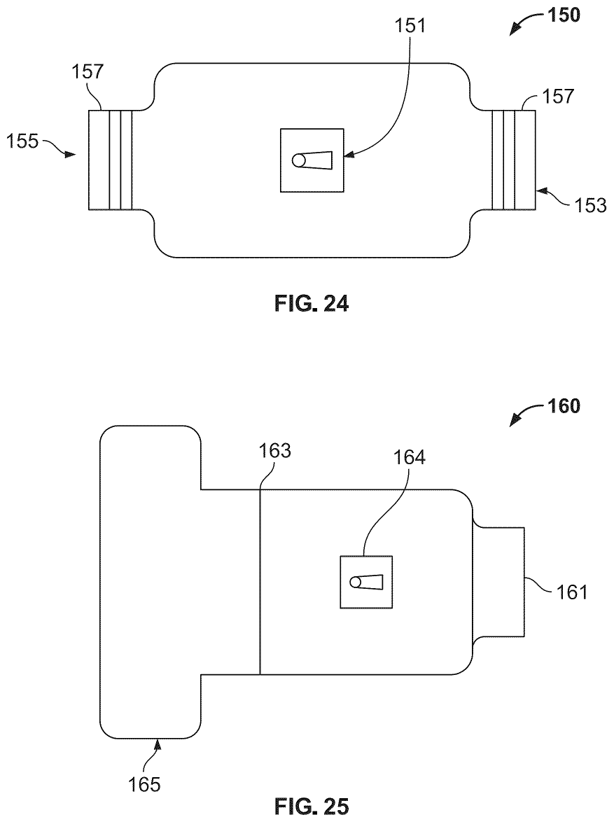

While the inventive connector can be used like a typical take off that connects a flexible duct to a main or branch line, the inventive connector can also include differently configured inlets and outlets. For example, if a need exists to have a damper in a duct for flow control, the inventive insulated connector could have the inlet and outlet configured so that it could attach between two duct ends. An example of this is shown schematically in FIG. 24. Here, the inventive connector with its damper assembly, foam insulation, and inlet and outlet is designated by the reference numeral 150, with the raised surface portion and its surface profile for controlling the position of the control arm schematically designated as 151. The connector 150 can be configured to have an inlet 153 and an outlet 155, each shaped to connect to a flexible duct. The third surface profile (see FIG. 6) representing the crushable foam ribs or layer of foam insulation is designated as 157 can be located on either or both of the inlet and outlets 153 and 155. Of course, the insulated connector 150 could just employ the foam insulation layer on the body of the connector to create the desired surface profile for the control arm of the damper assembly and the inlet and outlet 153 and 155 can attach to ducts using conventional techniques, flex ties, tape, adhesives, or combinations thereof. In this embodiment, the advantages of the invention in terms of minimizing leakage due to the existence of the damper assembly and allowing the damper assembly to be operational still exists, just not in a conventional take off application.

While the inventive connector is shown to link two ducts in FIG. 24, it could be used in other applications where a damper assembly could be needed. For example and as shown in FIG. 25, another insulated connector, similar to that shown in FIG. 6 with a damper assembly and surface profile, is designated as 160 with an inlet 161 and an outlet 163. The surface profile that holds the control arm is schematically shown as 164. The outlet 163 is in communication with a register box 165, which is a known connector that links a duct to a space in a structure to receive conditioned or unconditioned air. The register box 165 can be connected to the outlet 163 of the damper assembly containing connector in any known fashion. In this example, the damper assembly is located at the termination of a duct run rather than at the onset of such a run, wherein the duct is attached to a main or branch line of an HVAC system.

FIGS. 24 and 25 are just two examples of how the inventive connector could be utilized outside the realm of a typical take off. More particular, the insulated connector with its sealing feature of the damper assembly and ability to still allow for damper operation given the first surface profile can be utilized in virtually any application where a damper assembly would be needed in an HVAC system. In some instances, the insulated connector may employ the crushable rib/foam layer option and/or the lip at the inlet of the insulated connector for enhanced sealing connection purposes but in other instances, use of the crushable ribs/foam layer option/lip may not be practical.

The invention also includes the use of the damper assembly-containing insulated connector to move conditioned or unconditioned air in a building between two locations. In some instances, the insulated connector can be used as a take off to connect a main duct or branch line of an HVAC system to a flexible duct. In other instances, the insulated connector could be inserted in a running duct line so that the damper control is available in the run of the duct rather than at a take off from a main or branch line. The insulated connector with its damper assembly could also be positioned upstream of another kind of connector, e.g., a register box, where control of the flow of the conditioned or unconditioned air is needed.

As such, an invention has been disclosed in terms of preferred embodiments thereof which fulfills each and every one of the objects of the present invention as set forth above and provides a new and improved connector having a damper assembly associated therewith, the improved connector including a layer of foam insulation for sealing any openings in the connector and allowing a control arm of the damper assembly to be exposed for movement thereof, and a method of using the connector for moving conditioned or unconditioned air.

Of course, various changes, modifications, and alterations from the teachings of the present invention may be contemplated by those skilled in the art without departing from the intended spirit and scope thereof. It is intended that the present invention only be limited by the terms of the appended claims.

We claim:

1. A damper assembly-containing connector comprising:
a housing with an inlet and an outlet;
a damper assembly designed to control air flow through the housing, the damper assembly including a damper rod mounted in at least one opening in the housing of the connector, the damper rod having a damper plate attached thereto, one end of the damper rod including a control arm configured to move the damper plate between a fully open position, a fully closed position, and positions therebetween; and
a layer of foam insulation covering at least a portion of the housing having the at least one opening, an end portion of the damper rod extending through the foam insulation layer with the control arm positioned in a first surface profile of the foam insulation surrounding at least a portion of the housing and held in a first operating position, the surface profile allowing the control arm to be moved to a second operating position.

2. The connector of claim 1, wherein the outlet of the connector has a cylindrical or square/rectangular shape, the foam insulation surrounding at least a portion of the outlet and including a plurality of crushable ribs or a crushable foam insulation layer extending around an outer surface of the outlet as a second surface profile, the crushable ribs or crushable foam insulation layer configured to receive a means for attaching a flexible duct to the outlet, crushing of the crushable ribs or crushable foam insulation layer as part of attaching the flexible duct to the outlet enhancing a seal between the flexible duct and the outlet.

3. The connector of claim 2, wherein the foam insulation surrounding at least a portion of the outlet includes the crushable ribs.

4. The connector of claim 1, wherein foam insulation surrounding the housing includes a plurality of crushable ribs extending around a circumference of the foam insulation surrounding the housing as a third surface profile, the crushable ribs configured to receive a means for attaching a flexible duct to the foam insulation surrounding the housing, crushing of the crushable ribs layer as part of attaching the flexible duct to the foam insulating surrounding the housing enhancing a seal between the flexible duct and the housing.

5. The connector of claim 2, wherein foam insulation surrounding the housing includes a plurality of crushable ribs extending around a circumference of the foam insulation surrounding the housing as a third surface profile, the crushable ribs configured to receive a means for attaching a flexible duct to the foam insulation surrounding the housing, crushing of the crushable ribs layer as part of attaching the flexible duct to the foam insulating surrounding the housing enhancing a seal between the flexible duct and the housing.

6. The connector of claim 1, wherein the foam insulation is a polyurethane foam.

7. The connector of claim 2, wherein the foam insulation is a polyurethane foam.

8. The connector of claim 4, wherein the foam insulation is a polyurethane foam.

9. The connector of claim 1, wherein the inlet includes a flange.

10. The connector of claim 1, wherein the first surface profile includes a recess configured to receive at least a portion of the control arm.

11. The connector of claim 10, wherein the recess is either formed in a surface of the foam insulation surrounding the portion of the housing as the first surface profile or the first surface profile includes a first raised portion of the foam insulation, the first raised portion extending from the surface of the foam insulation layer surrounding the portion of the housing and including the recess.

12. The connector of claim 11, where the first surface profile includes the first raised portion and further comprises at least one second raised portion positioned adjacent the recess, preferably a pair of second raised portions, each positioned adjacent the recess, the at least one second raised portion or the pair of second raised portions having a surface for engaging the control arm when moved from the recess to the second operating position.

13. The connector of claim 12, further comprising a stop extending from a surface of the foam insulation layer, the stop positioned to restrict movement of the control arm after movement from the recess.

14. The connector of claim 1, wherein the inlet and outlet are similarly shaped.

15. The connector of claim 1, wherein the foam insulation layer includes a lip extending along a periphery of the foam insulation layer at the inlet.

16. In a method of moving unconditioned or conditioned air in an HVAC system in a building, the improvement comprising using the connector of claim 1 in a heating and ventilating (HVAC) system.

17. The method of claim 16, wherein the outlet of the connector has a cylindrical or square/rectangular shape, the foam insulation surrounding at least a portion of the outlet and including a plurality of crushable ribs or a crushable foam insulation layer extending around an outer surface of the outlet as a second surface profile, the crushable ribs or crushable foam insulation layer configured to receive a means for attaching a flexible duct to the outlet, crushing of the crushable ribs or crushable foam insulation layer as part of attaching the flexible duct to the outlet enhancing a seal between the flexible duct and the outlet.

18. The method of claim 16, wherein foam insulation surrounding the housing includes a plurality of crushable ribs extending around a circumference of the foam insulation surrounding the housing as a third surface profile, the crushable ribs configured to receive a means for attaching a flexible duct to the foam insulation surrounding the housing, crushing of the crushable ribs layer as part of attaching the flexible duct to the foam insulating surrounding the housing enhancing a seal between the flexible duct and the housing.

19. The method of claim 18, wherein foam insulation surrounding the housing includes a plurality of crushable ribs extending around a circumference of the foam insulation surrounding the housing as a third surface profile, the crushable ribs configured to receive a means for attaching a flexible duct to the foam insulation surrounding the housing, crushing of the crushable ribs layer as part of attaching the flexible duct to the foam insulating surrounding the housing enhancing a seal between the flexible duct and the housing.
